(19) United States
(12) Patent Application Publication
(10) Pub. No.: US 2026/0250137 A1
(43) Pub. Date: Aug. 27, 2026

(54) METHOD OF PREPARING PORE-ADJUSTABLE CARBON MOLECULAR SIEVE BY HEAVY OIL BINARY ACTIVATION AND APPLICATION THEREOF

(71) Applicant: SOUTHEAST UNIVERSITY, Nanjing (CN)

(72) Inventors: Huiyan ZHANG, Nanjing (CN); Gang WU, Nanjing (CN); Yinhai SU, Nanjing (CN); Yunwei ZHANG, Nanjing (CN); Rui XIAO, Nanjing (CN); Sheng CHU, Nanjing (CN); Yujie TAO, Nanjing (CN)

(73) Assignee: SOUTHEAST UNIVERSITY, Nanjing (CN)

(21) Appl. No.: 19/449,494

(22) Filed: Jan. 15, 2026

Related U.S. Application Data
(63) Continuation of application No. PCT/CN2025/104155, filed on Jun. 27, 2025.

(30) Foreign Application Priority Data
Feb. 26, 2025 (CN) 202510216424.X

(51) Int. Cl. C01B 32/342; B01J 20/20; C01B 32/318; C02F 1/28; C02F 101/30

(52) U.S. Cl. CPC C01B 32/342; B01J 20/20; C01B 32/318; C02F 1/283; C02F 2101/308

(57) ABSTRACT

A method of preparing a pore-adjustable carbon molecular sieve by heavy oil binary activation and an application thereof are provided. The method includes: mixing heavy oil with a binary activator and leaving the mixture to stand and then forming a carbon-containing precursor mixture; where the binary activator is calcium citrate and potassium oxalate; performing pyrolysis activation on the carbon-containing precursor mixture under inert atmosphere, and cooling the mixture after pyrolysis to obtain a biological activated carbon; washing and drying the biological activated carbon to obtain a carbon molecular sieve. The method and the application thereof have the advantages of greenness, environmental protection, convenient process and efficient production; the prepared carbon molecular sieve has developed pore structure and centralized pore size distribution, having good adsorption characteristics, having broad application prospect in water treatment, and realizing the comprehensive disposal of the resource utilization of the disused heavy oil and dye wastewater.

### CROSS REFERENCE TO THE RELATED APPLICATIONS

This application is a continuation application of International Application No. PCT/CN2025/104155, filed on June 27, 2025, which is based upon and claims priority to Chinese Patent Application No. 202510216424.X, filed on February 26, 2025, the entire contents of which are incorporated herein by reference.

### TECHNICAL FIELD

The present disclosure relates to the field of biomass resource utilization and water treatment technologies and in particular to a method of preparing a pore-adjustable carbon molecular sieve by heavy oil binary activation and an application thereof.

### BACKGROUND

With the accelerated development of global industrialization process, the industrial wastewater treatment problem has become a huge challenge for the sustainable development of the ecological environment. The statistics data shows that global industrial wastewater discharge not treated to standard each year has exceeded several hundred billion cubic meters, 80% of which is the dye wastewater which is directly discharged into natural waters. The annual total discharge of such dye wastewater reaches the scale of several hundred million tons and is still on the increase. The industrial wastewater containing complex organic macromolecular dyes, especially those typical pollutants such as methyl orange, Congo red, methylene blue (MB) and so on, has pose serious threat to the water environment system. The MB has drawn special attention due to its special physicochemical properties. This substance not only has obvious environmental persistence and bioaccumulation but also transmits multiple toxic effects to living bodies through food chain. Researches demonstrate that MB exposure can bring oxidative stress response to aquatic organisms, leading to DNA damage and abnormal reproduction functions. Also, it should be noted that the MB pollution has diffused from water environment to soil system, forming a composite pollution pattern and posing a potential risk to the farmland ecological safety and underground water quality. For this reason, wide attention has been drawn to effective purification treatment of the dye wastewater.

In the field of existing water treatment technologies, the porous activated carbon material is widely applied to wastewater treatment and purification field due to its low cost, high specific surface area, large pore volume, regeneration and excellent adsorption characteristics. The common activators used in traditional production process of the activated carbon material are KOH and K₂CO₃.

For example, the literature (Wang K , Xu S .Preparation of High Specific Surface Area Activated Carbon from Petroleum Coke by KOH Activation in a Rotary Kiln[J].Processes, 2024, 12(2).DOI:10.3390/pr12020241.) discloses a new method of preparing an activated carbon (AC) by activating petroleum coke (PC) with KOH in a steel ball-loaded rotary kiln. The molten KOH is used to cause a reaction mixture to expand under a low activation temperature, and the molten K₂O causes particles to agglomerate under a high temperature. The steel balls promote the heat and mass transfer of a reactor to mitigate expansion and agglomeration so as to promote the pore structure development of the AC. In the activation process, CO₂ is introduced to convert K₂O into thermosetting K₂CO₃ to further reduce particle agglomeration and form more AC mesopores. In addition, the literature (Wu C, Liu J, Wang Y, et al. A clean method for controlling pore structure development in potassium activation systems to improve CO₂ adsorption properties of biochar[J].Science of the Total Environment, 2024, 954.DOI:10.1016/j.scitotenv.2024.176429.) discloses that, with the assistance of KCI in the activation process, three activators (KOH, KHCO₃, K₂CO₃) are used to prepare a CO₂ adsorbent with high specific surface area and excellent adsorption performance. However, these methods are corrosive, which can not only cause serious corrosion to the equipment but also bring the risk of heavy metal pollution. Analyzed from the microstructure of the carbon material, the activated carbon produced by these methods has well-developed pore structure and large pore volume, but its pore size structure is relatively disperse and most pores are unable to play effective role, thereby limiting the entire performance of the activated carbon. Based on the above, in order to break through the bottleneck of the material performance of the carbon molecular sieve, it is necessary to develop a green chemistry-based binary activation technology to construct a hierarchical pore system by synergistic physics-chemistry activation mechanism, so as to realize accurate control on the distribution of pore size, which has significant engineering application value for pushing the scientific development of environmental functional materials.

Heavy oil is a non-water-soluble liquid, which is mainly generated by macromolecular deposition in the processes such as biomass pyrolysis or gasification or the like. The heavy oil has the characteristics of complex composition, high carbon content, low ash content, large viscosity, good thermoplasticity and ease of polymerization. These characteristics make it impossible to directly purifying and upgrading it by the purification methods such as distillation and extraction and the like to a high-valued chemical or liquid fuel. A novel processing utilization process can be developed to convert the disused heavy oil into a carbon-based molecular sieve adsorbent material with highly-centralized pore structure by a thermal chemistry method and use it as high-performance absorbent material to remove pollutants through water treatment, which not only realizes waste reuse but also effectively solves the problem of difficulty in direct utilization of the heavy oil, providing a new approach to environmental pollution control.

### SUMMARY

In view of the above defects in the prior arts, according to a first aspect of the present disclosure, there is provided a method of preparing a pore-adjustable carbon molecular sieve by heavy oil binary activation in a convenient and efficient process, which includes the following steps.

(1) selecting a heavy component obtained by pine wood pyrolysis as heavy oil, mixing the heavy oil with a binary activator and letting the mixture to stand to form a carbon-containing precursor mixture; wherein the binary activator is calcium citrate and potassium oxalate; by weight, a ratio of the heavy oil to calcium citrate to potassium oxalate is 2:1:0.25 to 2;

(2) performing pyrolysis activation on the carbon-containing precursor mixture under inert atmosphere, and cooling the mixture after pyrolysis to obtain a biological activated carbon;

(3) washing and drying the biological activated carbon to obtain a carbon molecular sieve.

Preferably, in the step (1), by weight, a ratio of the heavy oil to calcium citrate to potassium oxalate is 2:1:0.25 to 2.

The composition ratio of the heavy oil and the binary activator should be controlled within the range preferred in the present disclosure. If the ratio of calcium citrate is too low, the ordered arrangement process of the carbon microcrystals can be weakened, which is unfavorable for forming a highly-graphitized carbon and weakens the reaction of subsequent K⁺ or CO₂ molecules to the carbon skeleton. If the ratio of calcium citrate is too high, its pyrolysis can generate a CaO template agent and cause more site-occupying pore formation reactions, and the mesopore structures of the produced activated carbon can be greatly increased, unfavorable for generating a activated carbon adsorbent material with highly-centralized pore size distribution. If the total use amount of the binary activator is continuously increased, the environmental/economic sustainability is not favored. For this reason, the binary activator with a proper mixing weight ratio can help synergistic effect between the binary activator, so as to form an activated carbon with molecular sieve characteristics and highly-centralized pore size distribution.

Preferably, in the step (1), the mixing time is 5 to 30 min and the standing time is 5 to 30 min.

Standing after mixing can help ensure the components are mixed evenly.

Preferably, in the step (2), an initial temperature of the pyrolysis is room temperature, a heating rate is 5-10 ℃/min, a pyrolysis temperature is 600 to 800℃, and an incubation temperature is 10 to 60 min;

Preferably, in the step (2), a gas type of the inert atmosphere is at least one of nitrogen, argon and helium; a gas flowrate is 50 to 100 mL/min

Persons of skills in the prior arts can select a proper pyrolysis device, for example, a pyrolysis furnace, according to actual conditions. A general pyrolysis furnace includes a fluidized bed reactor, and a fixed bed reactor and the like. The fixed bed reactor has some advantages over the fluidized bed reactor, namely, the activator can be in full contact with the heavy oil for reaction.

Preferably, in the step (3), the biological activated carbon is washed with a dilute acid and water and then dried under 100-150℃ to obtain a carbon molecular sieve.

Preferably, the type of the dilute acid includes at least one of hydrochloric acid, nitric acid and sulfuric acid; a concentration of the dilute acid is 0.1 to 1 mol/L.

According to a second aspect of the present disclosure, there is provided a carbon molecular sieve with developed pore structure and centralized pore size distribution, which is prepared by the method in the first aspect of the present disclosure.

According to a third aspect of the present disclosure, there is provided an application of the carbon molecular sieve of the second aspect of the present disclosure as an adsorbent material in water treatment.

Preferably, the carbon molecular sieve is used as an adsorbent material to remove dye pollutants in wastewater.

Based on the above technical scheme, the designing idea and principle of the present disclosure are as follows.

The present disclosure provides a method of preparing an activated carbon material by heating the heavy components in the heavy oil to go through polymerization reaction based on simple thermal chemical conversion (pyrolysis activation). In the process, the heavy oil has the characteristics of complex composition, high carbon content, low ash content, good thermoplasticity, and ease of polymerization as well as the shortcomings of high viscosity, poor fluidity and difficulty of direct utilization, and the disused heavy oil is efficiently converted and applied to water purification treatment. Furthermore, the synergistic coupling effect between the binary green activator is fully exerted to promote the efficient progress of the activation reaction. The biomass-derived heavy oil used has a wide source, a high carbon content and a high viscosity and is in a semi-liquid state, and can perfectly dissolve the binary organic salt activator, so that the macromolecular components in the heavy oil can fully contact with the activator molecules, helping the activator to play efficient role and promoting the efficient progress of the activation reaction.

In the traditional process, the “activators” selected in the thermal chemical conversion process are inorganic salts such as KOH, K₂CO₃ and the like, which themselves have strong corrosiveness and non-environment-friendly. In the present disclosure, relatively mild organic salts such as calcium citrate and potassium oxalate are selected as activators which are green and environment-friendly and the prepared carbon material has the characteristics of molecular sieve.

The pyrolysis activation process of the heavy oil is relatively complex. The calcium citrate activator generates a metal oxide (CaO) and releases CO₂ gas in the pyrolysis process. The CaO is designed as a template agent to guide carbon microcrystals to be arranged in order to form a highly-graphitized carbon material, whereas the evolution of CO₂ is used to form a microporous carbon. Furthermore, in the activation process, the calcium citrate activator can dissociate to yield calcium ions (Ca²⁺) in a solution, and Ca²⁺ can promote inter-molecular crosslinking due to its high charge density, and connect the heavy component macromolecules in the heavy oil to form a macromolecular skeleton bridge, helping the polymerization reaction of the macromolecules.

The potassium oxalate activator can form potassium oxide and release CO₂ in the pyrolysis process. The potassium oxide can perform gasification reaction (C + K₂O → CO↑+ 2K) with with carbonaceous micromolecules in the heavy components under high temperature, and the generated CO₂ can perform etching reaction (CO₂ + C → 2CO) with the carbon skeleton, helping form a microporous carbon. Furthermore, in the activation process, the potassium oxide activator can dissociate to yield potassium ions (K⁺) in a solution and the K⁺ can promote generation of free radicals and accelerate chain cracking reaction. The existence of the K⁺ helps occurrence of the chain cracking reaction to form more free radicals of aromatic hydrocarbon. This process helps Ca²⁺ to capture the free radicals generated by cracking, and the synergistic effect between them further promotes condensation polymerization reaction to form polycyclic aromatic hydrocarbon. Furthermore, the synergistic effect between the binary activator helps dynamically adjust the pore structure.

Therefore, this method helps form a carbon molecular sieve with uniform pore structure and centralized pore size distribution, which greatly enhances the quality of the carbon products. The carbon molecular sieve is applied to efficient water treatment to efficiently dispose of disused heavy oil, and at the same time, the dye wastewater is synergistically purified and treated, so as to realize comprehensive disposal of resource utilization of disused heavy oil and dye wastewater.

Compared with the prior arts, the present disclosure has the following advantages and beneficial effects.

The present disclosure provides a method of preparing a pore-adjustable carbon molecular sieve by heavy oil binary activation, which has the advantages of greenness, environmental protection, convenient process and efficient production.

The present disclosure provides a carbon molecular sieve, which has developed pore structure and centralized pore size distribution, having good adsorption characteristics.

The present disclosure provides an application of a carbon molecular sieve as an adsorbent material in water treatment, having broad application prospect.

### BRIEF DESCRIPTIONS OF THE DRAWINGS

FIG. 1 is a flowchart illustrating a method of preparing a pore-adjustable carbon molecular sieve by heavy oil binary activation and an application thereof.

FIGS. 2A-2F are comparison diagrams of micro-morphology of the carbon molecular sieve adsorbents prepared in examples, where FIGS. 2A-2F sequentially correspond to the observation results of HBAC-0 to HBAC-5.

FIG. 3 is a comparison diagram of X-ray diffraction of the carbon molecular sieve adsorbents prepared in examples.

FIGS. 4A-4I show representation results of physical parameters of the carbon molecular sieve adsorbents prepared in examples, where FIG. 4A is a nitrogen adsorption and desorption curve of each carbon molecular sieve adsorbent, FIG. 4B is an overall pore specific surface area of each carbon molecular sieve adsorbent, FIG. 4C is a micropore specific surface area of each carbon molecular sieve adsorbent, and FIGS. 4D-4I sequentially correspond to comparison diagrams of the pore size distribution curves of HBAC-0 to HBAC-5.

FIG. 5 is a comparison diagram of an adsorption rate and a removal rate of an adsorbent sample for MB adsorption under different experimental conditions in the applications of the present disclosure.

FIGS. 6A-6B are comparison diagrams of influence of an adsorbent sample on MB adsorption under different experimental conditions in the applications of the present disclosure; where FIG. 6A is a relationship diagram of MB initial concentration and adsorption capacity, and FIG. 6B is a relationship diagram of adsorption time and adsorption capacity.

### DETAILED DESCRIPTIONS OF THE EMBODIMENTS

The present disclosure will be further described below by way of examples, but the present disclosure is not thereby limited to the scope of the mentioned examples. The experimental methods without specific conditions in the following examples can be referred to conventional methods and conditions or be selected as per commodity manual.

In the following examples:

The commercial source of the commercial activated carbon is Huajing Activated Carbon Co., Ltd. and the product type is coconut shell water-purifying carbon.

The biomass heavy oil is obtained by pyrolyzing pine wood powder under inert atmosphere (nitrogen atmosphere with the purity of 99.999%) and 500 ℃ for 1 h and collecting a lower-layer viscous liquid phase of the biological oil by condensation.

### Example 1

The method of preparing a pore-adjustable carbon molecular sieve by heavy oil binary activation includes the following steps:

(1) selecting a heavy component obtained by pine wood pyrolysis as heavy oil sample, and by weight ratio of 2:1:0.125, weighing heavy oil, and calcium citrate and potassium oxalate activators respectively and mixing fully and then leaving the mixture to stand to form a carbon-containing precursor mixture;

(2) transferring the carbon-containing precursor mixture to a fixed bed reactor for pyrolysis, and introducing nitrogen as a reaction atmosphere with a nitrogen flowrate of 100 mL/min, and heating to 800℃ at a heating rate of 10 ℃/min and then incubating for 60 min; after pyrolysis is completed, cooling to obtain a biological activated carbon;

(3) after collecting the biological activated carbon, washing the biological activated carbon several times to neutral by using a dilute acid and deionized water, and drying by a blast drying oven to obtain a carbon molecular sieve adsorbent denoted as HBAC-1.

### Example 2

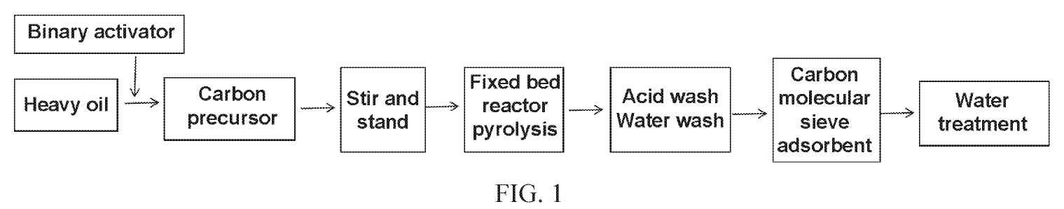

The method of preparing a pore-adjustable carbon molecular sieve by heavy oil binary activation includes the following steps as shown in FIG. 1:

(1) selecting a heavy component obtained by pine wood pyrolysis as heavy oil sample, and by weight ratio of 2:1:0.25, weighing heavy oil, and calcium citrate and potassium oxalate activators respectively and mixing fully and then leaving the mixture to stand to form a carbon-containing precursor mixture;

(2) transferring the carbon-containing precursor mixture to a fixed bed reactor for pyrolysis, and introducing nitrogen as a reaction atmosphere with a nitrogen flowrate of 100 mL/min, and heating to 800℃ at a heating rate of 10 ℃/min and then incubating for60 min; after pyrolysis is completed, cooling to obtain a biological activated carbon;

(3) after collecting the biological activated carbon, washing the biological activated carbon several times to neutral by using a dilute acid and deionized water, and drying by a blast drying oven to obtain a carbon molecular sieve adsorbent denoted as HBAC-2.

### Example 3

The method of preparing a pore-adjustable carbon molecular sieve by heavy oil binary activation includes the following steps:

(1) selecting a heavy component obtained by pine wood pyrolysis as heavy oil sample, and by weight ratio of 2:1:0.5, weighing heavy oil, and calcium citrate and potassium oxalate activators respectively and mixing fully and then leaving the mixture to stand to form a carbon-containing precursor mixture;

(2) transferring the carbon-containing precursor mixture to a fixed bed reactor for pyrolysis, and introducing nitrogen as a reaction atmosphere with a nitrogen flowrate of 100 mL/min, and heating to 800℃ at a heating rate of 10 ℃/min and then incubating for 60 min; after pyrolysis is completed, cooling to obtain a biological activated carbon;

(3) after collecting the biological activated carbon, washing the biological activated carbon several times to neutral by using a dilute acid and deionized water, and drying by a blast drying oven to obtain a carbon molecular sieve adsorbent denoted as HBAC-3.

### Example 4

The method of preparing a pore-adjustable carbon molecular sieve by heavy oil binary activation includes the following steps:

(1) selecting a heavy component obtained by pine wood pyrolysis as heavy oil sample, and by weight ratio of 2:1:1, weighing heavy oil, and calcium citrate and potassium oxalate activators respectively and mixing fully and then leaving the mixture to stand to form a carbon-containing precursor mixture;

(2) transferring the carbon-containing precursor mixture to a fixed bed reactor for pyrolysis, and introducing nitrogen as a reaction atmosphere with a nitrogen flowrate of 100 mL/min, and heating to 800℃ at a heating rate of 10 ℃/min and then incubating for 60 min; after pyrolysis is completed, cooling to obtain a biological activated carbon;

(3) after collecting the biological activated carbon, washing the biological activated carbon several times to neutral by using a dilute acid and deionized water, and drying by a blast drying oven to obtain a carbon molecular sieve adsorbent denoted as HBAC-4.

### Example 5

The method of preparing a pore-adjustable carbon molecular sieve by heavy oil binary activation includes the following steps:

(1) selecting a heavy component obtained by pine wood pyrolysis as heavy oil sample, and by weight ratio of 2:1:2, weighing heavy oil, and calcium citrate and potassium oxalate activators respectively and mixing fully and then leaving the mixture to stand to form a carbon-containing precursor mixture;

(2) transferring the carbon-containing precursor mixture to a fixed bed reactor for pyrolysis, and introducing nitrogen as a reaction atmosphere with a nitrogen flowrate of 100 mL/min, and heating to 800℃ at a heating rate of 10 ℃/min and then incubating for 60 min; after pyrolysis is completed, cooling to obtain a biological activated carbon;

(3) after collecting the biological activated carbon, washing the biological activated carbon several times to neutral by using a dilute acid and deionized water, and drying by a blast drying oven to obtain a carbon molecular sieve adsorbent denoted as HBAC-5.

### Control example 1

The commercial activated carbon (CAC) selected for this control example is a blank control adsorbent.

### Control example 2

The preparation steps of the unitarily-activated heavy oil-based activated carbon in the control example as as follows:

(1) selecting a heavy component obtained by pine wood pyrolysis as heavy oil sample, and by weight ratio of 1:1, weighing heavy oil, and potassium oxalate activator respectively and mixing fully and then leaving the mixture to stand to form a carbon-containing precursor mixture;

(2) transferring the carbon-containing precursor mixture to a fixed bed reactor for pyrolysis, and introducing nitrogen as a reaction atmosphere with a nitrogen flowrate of 100 mL/min, and heating to 800℃ at a heating rate of 10 ℃/min and then incubating for 60 min; after pyrolysis is completed, cooling to obtain a biological activated carbon;

(3) after collecting the biological activated carbon, washing the biological activated carbon several times to neutral by using a dilute acid and deionized water, and drying by a blast drying oven to obtain a unitarily-activated heavy oil-based activated carbon denoted as HBAC-0.

### Test example 1

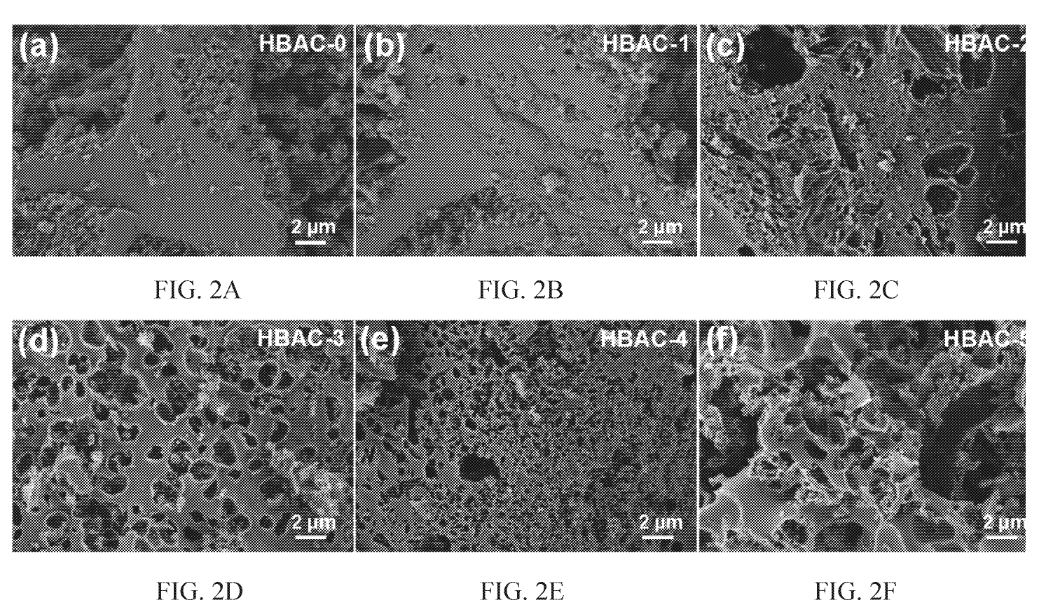

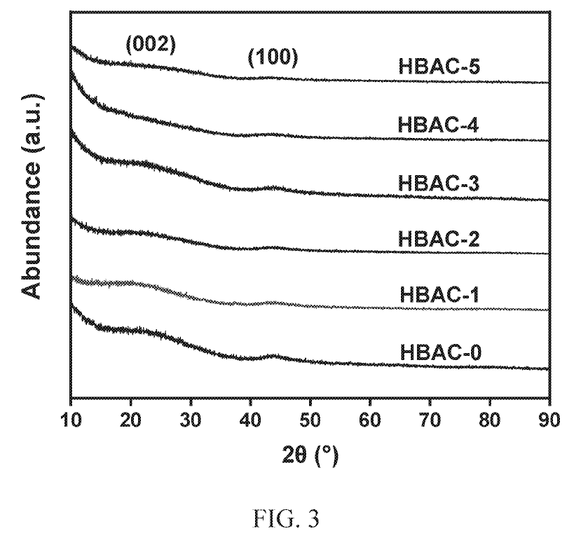

With a cold field emission scanning electron microscope, the micro-morphology of the carbon molecular sieve adsorbent is observed with results shown in FIGS. 2A-2F. The micro-morphology of the HBAC-0 is shown in FIG. 2A, where the HBAC-0 is in the shape of irregular particle and has a pore structure on surface. The micro-morphologies of the HBAC-1 to HBAC-5 are shown in FIGS. 2A-3F, where the HBAC-1 to HBAC-5 are all in the shape of irregular particles. Furthermore, with increase of the dosage of the potassium oxalate activator, the pore structure on their surfaces is increasingly developed.

With an X-ray diffractometer, the crystal structure of the carbon molecular sieve adsorbent is tested with the results shown in FIG. 3. From the FIG. 3, it can be seen that the crystal structure of the HBAC-0 has two two crystal surfaces (002) and (100) typical of carbon, and the HBAC-1 to HBAC-5 also have two crystal surfaces (002) and (100) typical of carbon material.

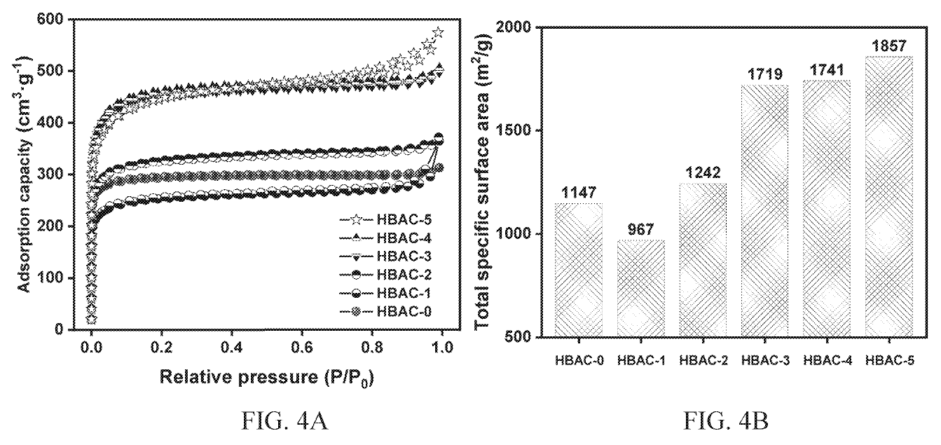

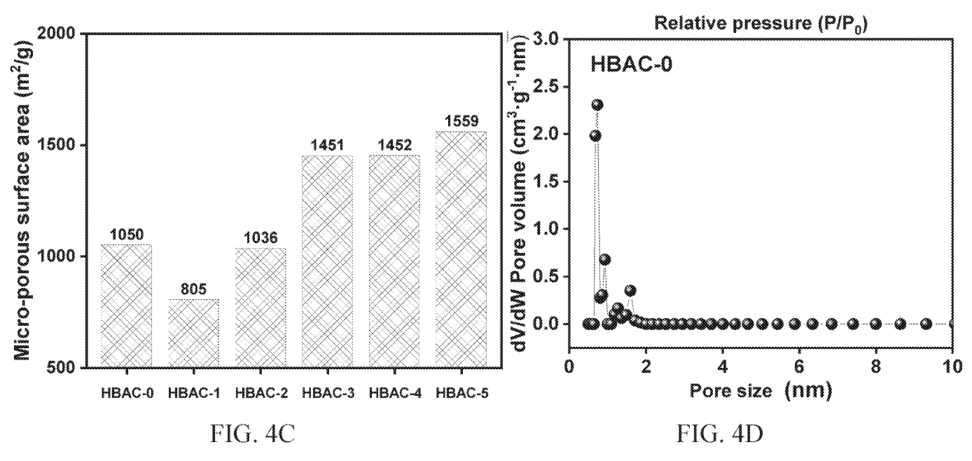

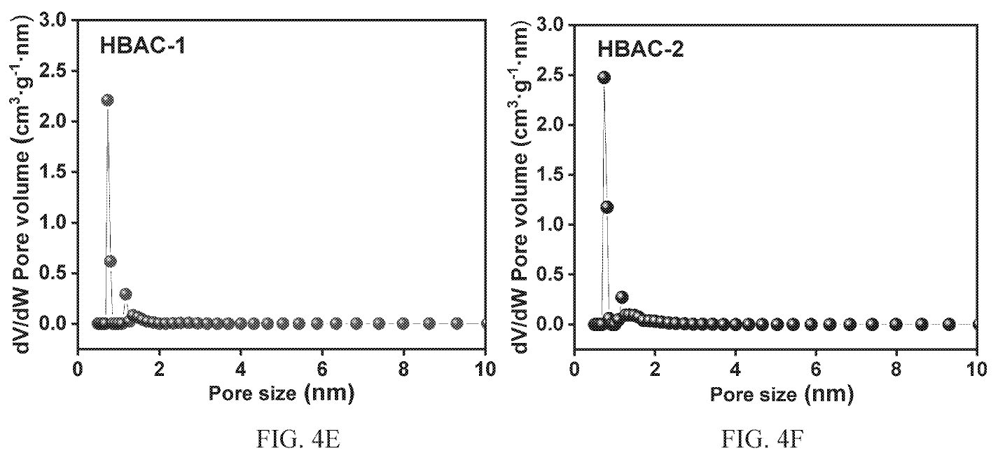

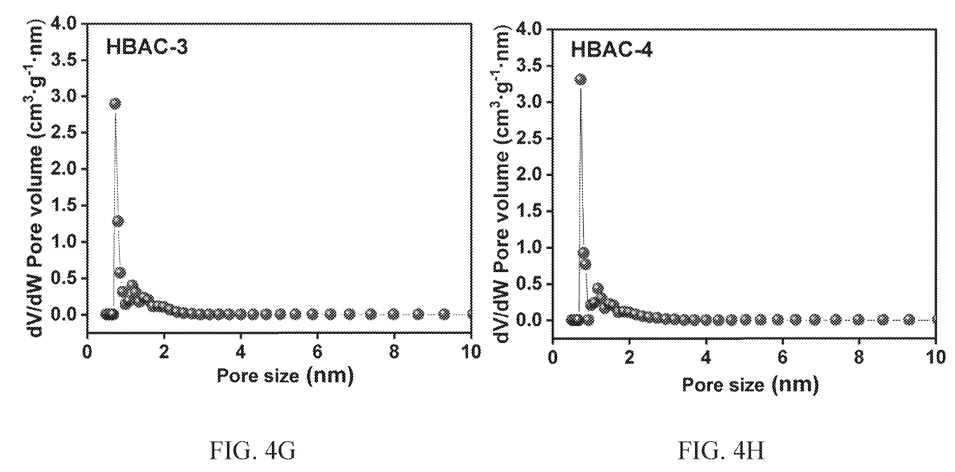

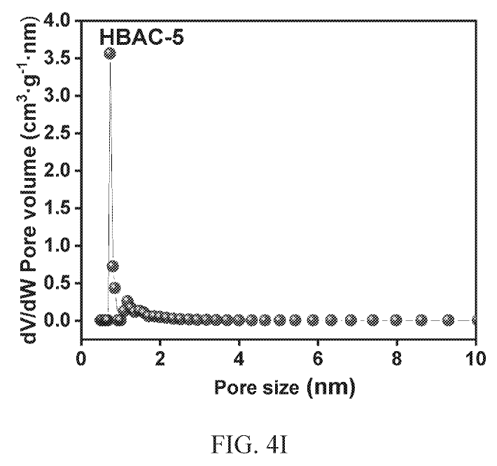

With an automatic specific surface area and porosity analyzer, the pore structure of the carbon molecular sieve adsorbent is analyzed with the results shown in FIGS. 4A-4I. The curves of the nitrogen adsorption and desorption and pore size distribution of the HBAC-0 adsorbent are shown in FIG. 4A and FIG. 4D, and its overall pore specific surface area and micro-pore specific surface area are 1147 m²/g and 1050 m²/g respectively as shown in FIG. 4B and FIG. 4C. The curves of the nitrogen adsorption and desorption and pore size distribution of the carbon molecular sieve adsorbent (HBAC-1 to HBAC-5) are shown in FIG. 4A and FIGS. 4E-4I. It can be clearly found that its pore size is mainly centralized near 0.8nm, having obvious structure characteristics of molecular sieve. The specific surface areas of the carbon molecular sieve are shown in FIG. 4B and FIG. 4C, where the overall pore specific surface area and the micro-pore specific surface area of the HBAC-5 reach 1857 m²/g and 1559 m²/g respectively.

### Test example 2

In the test example, the adsorption performance of each sample above in the actual applications is tested in the following steps:

(1) weighing and adding 50 mg of sample to a conical flask containing 50 mL of MB with a specific concentration (25-1000 mg/L) and transferring the conical flask to a shaker to allow adsorption to proceed for a period of time (0 to 1440 min) under room temperature;

(2) after the adsorption process is completed, performing solid-liquid separation on the solution to obtain a liquid phase containing no solid;

(3) transferring the pure liquid phase to a cuvette and testing its absorbance using an ultraviolet spectrophotometer with the UV wavelength set to 664 nm.

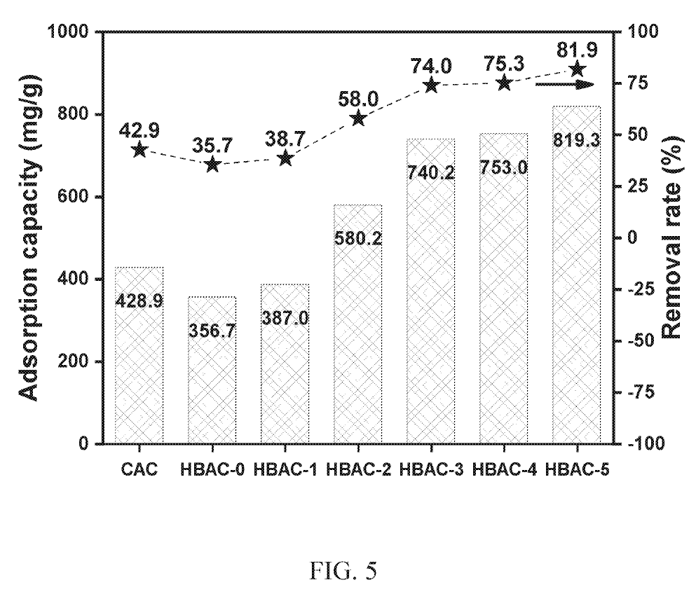

FIG. 5 reflects the equilibrium adsorption capacity and the MB removal rate of each adsorbent sample (CAC, HBAC-0 to BAC-5) when the initial concentration of the MB is 1000 mg/L. From the FIG. 5, it can be seen that the equilibrium adsorption capacity of the CAC can reach 428.9 mg/g and its MB removal rate is 42.9%. The equilibrium adsorption capacity of the HBAC-0 adsorbent obtained by activating the heavy oil with the unitary activator is only 356.7 mg/g and its MB removal rate is 35.7%. The adsorption capacity, for MB, of the carbon molecular sieve adsorbent (HBAC-1 to HBAC-5) obtained by activating the heavy oil with the binary activator is greatly increased, where the adsorption capacity and the removal rate of the HBAC-5 reaches the highest, i.e. 819.3 mg/g and 81.9% respectively, which are 1.91 times those of the commercial activated carbon and 2.30 times those of the unitarily-activated HBAC-0 adsorbent.

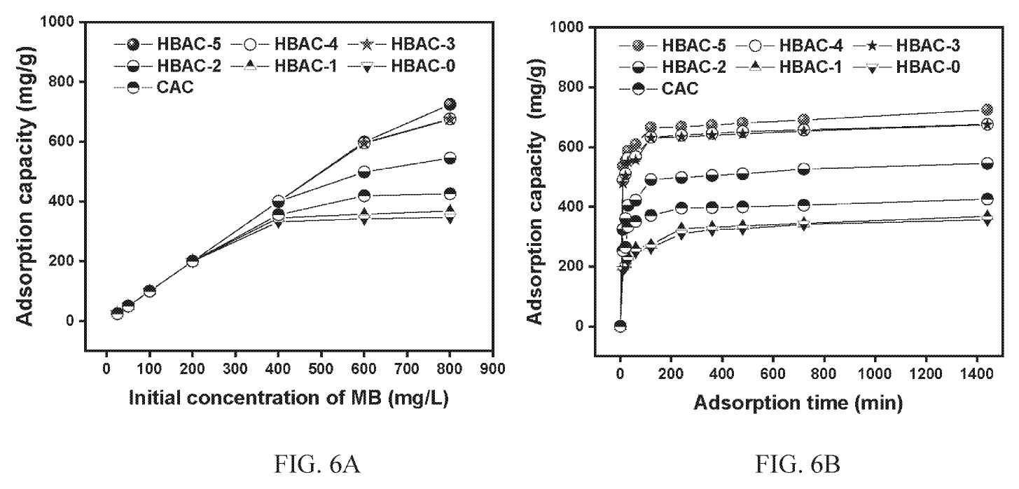

Under different MB initial concentrations, the adsorption capacity of each adsorbent sample for the MB is as shown in FIG. 6A. It can be seen that along with the increase of the MB initial concentration, the adsorption capacity of each adsorbent for the MB also has a tendency to increase gradually. When the MB initial concentration reaches 800 mg/L, the adsorption capacity of the HBAC-5 reaches 724.5 mg/g, which is 1.70 times that of the CAC (425.8 mg/g) and 1.97 times that of HBAC-0 (368.3 mg/g). In different adsorption times, the adsorption capacity of each adsorbent sample for the MB is as shown in FIG. 6B. The results show that, along with the increase of the adsorption time, the adsorption capacity of each adsorbent for the MB also has a tendency to increase gradually, where the adsorption capacities of the HBAC-3, HBAC-4 and HBAC-5 adsorbents after 24h adsorption are 674.6 mg/g, 676.3 mg/g and 724.5 mg/g respectively, which are far higher than that of the CAC (425.9 mg/g) and HBAC-0 (356.7 mg/g).

Compared with the prior arts, in the method of preparing a pore-adjustable carbon molecular sieve by binary green activation of heavy oil in the present disclosure, the heavy oil has the characteristics of complex composition, high carbon content, low ash content, good thermoplasticity, and ease of polymerization as well as the shortcomings of high viscosity, poor fluidity and difficulty of direct utilization, and the disused heavy oil is efficiently converted and applied to water purification treatment; furthermore, the synergistic coupling effect between the binary green activator is fully exerted to promote the efficient progress of the activation reaction. The biomass-derived heavy oil used has a wide source, a high carbon content and a high viscosity and is in a semi-liquid state, and can perfectly dissolve the binary organic salt activator, so that the macromolecular components in the heavy oil can fully contact with the activator molecules, helping the activator to play efficient role, promoting the efficient progress of the activation reaction, and helping formation of the carbon molecular sieve with uniform pore structure and centralized pore size distribution, thereby greatly improving the quality of the carbon products. The carbon molecular sieve is then applied to efficient water treatment to efficiently dispose of disused heavy oil, and at the same time, the dye wastewater is synergistically purified and treated, so as to realize resource utilization of disused heavy oil and dye wastewater.

In conclusion, in the present disclosure, the double-component green activator and the disused heavy oil are blended and composited creatively and by using the pyrolysis-activation- coupling processing technique under program-controlled temperature, the carbon molecular sieve material with oriented pore structure is successfully prepared. The obtained material has a prominent three-dimensional hierarchical pore system, and features highly centralized pore size distribution as compared with the carbon material prepared in the traditional methods. This material shows excellent adsorption performance for the typical organic pollutant methylene blue in waters, and can have a maximum adsorption capacity of 819 mg/g, which is increased by 91% over the commercially-available activated carbon, having excellent adsorption dynamics characteristics. This technology has the advantages of simple preparation process, greenness and environmental protection, and low costs and the like, which not only realizes resource utilization of the wastes of agriculture and forestry but also provides an innovative solution to the development of efficient water treatment adsorbing material, bringing significant environmental benefits and economic benefits.

The preferred embodiments of the present disclosure are detailed as above. It should be understood that persons of ordinary skill in the arts can make many modifications and changes based on the idea of the present disclosure without carrying out creative work. Therefore, all technical schemes obtained by those skilled in the arts through logic analysis, reasoning or limited experiments based on the prior arts according to the idea of the present disclosure shall fall within the scope of protection of the claims.

What is claimed is:

1. A method of preparing a pore-adjustable carbon molecular sieve by heavy oil binary activation, comprising the following steps:
(1) selecting a heavy component obtained by pine wood pyrolysis as heavy oil, mixing the heavy oil with a binary activator to obtain a mixture, and letting the mixture to stand to form a carbon-containing precursor mixture; wherein the binary activator is calcium citrate and potassium oxalate; and by weight, a ratio of the heavy oil to the calcium citrate to the potassium oxalate is 2:1:0.25 to 2;
(2) performing pyrolysis activation on the carbon-containing precursor mixture under inert atmosphere to obtain an activated mixture, and cooling the activated mixture after the pyrolysis activation to obtain a biological activated carbon; wherein an initial temperature of the pyrolysis activation is room temperature, a heating rate is 5-10 ℃/min, a pyrolysis temperature is 600 to 800℃, and an incubation temperature is 10 to 60 min; and
(3) washing and drying the biological activated carbon to obtain a carbon molecular sieve.

2. The method of preparing the pore-adjustable carbon molecular sieve by the heavy oil binary activation according to claim 1, wherein in the step (1), a mixing time is 5 to 30 min and a standing time is 5 to 30 min.

3. The method of preparing the pore-adjustable carbon molecular sieve by the heavy oil binary activation according to claim 1, wherein in the step (2), a gas type of the inert atmosphere is at least one of nitrogen, argon and helium; and a gas flowrate is 50 to 100 mL/min.

4. The method of preparing the pore-adjustable carbon molecular sieve by the heavy oil binary activation according to claim 1, wherein in the step (3), the biological activated carbon is washed with a dilute acid and water and then dried under 100-150℃ to obtain the carbon molecular sieve.

5. The method of preparing the pore-adjustable carbon molecular sieve by the heavy oil binary activation according to claim 4, wherein a type of the dilute acid comprises at least one of hydrochloric acid, nitric acid and sulfuric acid; and a concentration of the dilute acid is 0.1 to 1 mol/L.

6. A carbon molecular sieve, prepared by the method according to claim 1.

7. An application of the carbon molecular sieve according to claim 6 as an adsorbent material in water treatment.

8. The application according to claim 7, wherein the carbon molecular sieve is used as the adsorbent material to remove dye pollutants in wastewater.

9. The carbon molecular sieve according to claim 6, wherein in the step (1) of the method, a mixing time is 5 to 30 min and a standing time is 5 to 30 min.

10. The carbon molecular sieve according to claim 6, wherein in the step (2) of the method, a gas type of the inert atmosphere is at least one of nitrogen, argon and helium; and a gas flowrate is 50 to 100 mL/min.

11. The carbon molecular sieve according to claim 6, wherein in the step (3) of the method, the biological activated carbon is washed with a dilute acid and water and then dried under 100-150℃ to obtain the carbon molecular sieve.

12. The carbon molecular sieve according to claim 11, wherein in the method, a type of the dilute acid comprises at least one of hydrochloric acid, nitric acid and sulfuric acid; and a concentration of the dilute acid is 0.1 to 1 mol/L.
